(19) United States
(12) Patent Application Publication
(10) Pub. No.: US 2007/0078230 A1
(43) Pub. Date: Apr. 5, 2007

(54) Impedance type humidity sensing copolymer and method of producing the same

(75) Inventor: Yuan-Ho Lai, Hsinchu (TW)

Correspondence Address: TROXELL LAW OFFICE PLLC, 5205 LEESBURG PIKE, SUITE 1404, FALLS CHURCH, VA, 22041, US

(73) Assignee: Yuan-Ho Lai

(21) Appl. No.: 11/543,054

(22) Filed: Oct. 5, 2006

(30) Foreign Application Priority Data
Oct. 5, 2005 (TW) 094134792

(51) Int. Cl. C08F 32/00

(52) U.S. Cl. 525/326.1

(57) ABSTRACT

An impedance type humidity sensing copolymer and its manufacture method adopt an ionic conductive monomer having a humidity sensing leaving group and a reactive double bond, and a copolymerizing monomer having a reactive functional group and a reactive double bond. The reactive double bonds of the ionic conductive monomer and the copolymerizing monomer are copolymerized to produce a humidity sensing copolymer having a humidity sensing leaving group and a reactive functional group. The reactive functional groups of a crosslinking agent and the humidity sensing copolymer are crosslinked to produce a humidity sensing copolymer chain having a plurality of humidity sensing leaving groups, so as to form a crosslink structure on the humidity sensing polymer chain to meet the industrial requirements for a better water tolerance, or work together with an interpenetrating network (IPN) structure to improve the water tolerance and humidity sensing reliability of the product.

### BACKGROUND OF THE INVENTION

1. Field of the Invention

The invention relates to an impedance type humidity sensing copolymer and a method of producing the same, and more particularly to a humidity sensing copolymer that has a humidity sensing leaving group and a reactive functional group and uses the reactive functional group of a crosslinking agent to crosslink and combine an adjacent reactive functional group of the humidity sensing copolymer to produce a novel humidity sensing copolymer chain crosslink structure having a plurality of humidity sensing leaving groups.

2. Description of the Related Art

An impedance type polymer humidity sensor is a fast-developing and extensively used humidity sensor, but the humidity sensing polymer material used for making the impedance type polymer humidity sensor generally includes a strongly acidic electrolyte polymer (a tetraalkylammonium salt) that adsorbs water easily, so that when the humidity sensing polymer material is in a changing wet and dry environment and under the effect of dews, the humidity sensing polymer material may be dissolved or expanded due to the adsorption of water molecules, or an exfoliation may even occur at the interface between the humidity sensing polymer material and the substrate, such that the impedance type polymer humidity sensor may change, distort, or even lose its original properties.

To improve the reliability of using the humidity sensing element over a long period of time, there are two main trends of developing the humidity sensing polymer materials in the world. One trend is to find a way of improving the water tolerance of the polymer humidity sensing material by synthesis or modification technologies, and the other trend is to find a way of enhancing the adhesive force between the polymer humidity sensing material and the substrate material by a physical method or a chemical method.

To improve the water tolerance of the polymer humidity sensing material, both graft copolymerization used in early days and polymer humidity sensing material used nowadays apply the crosslinking and hardening technologies to a humidity sensing polymer chain, and an appropriate crosslinking agent is added into a humidity sensing polymer material solution, and the solution is coated onto a substrate material to form a humidity sensing polymer thin film layer, and then the thin film layer is heated or radiated by ultraviolet (UV) beams, so that the crosslinking agent and the humidity sensing polymer material are reacted and crosslinked to increase the molecular weight of the whole macromolecular structure and constitute a cubic molecular structure. An interpenetrating network (IPN) structure is also used. In other words, two or more polymer hardening systems are adopted to form different macromolecular chain structures, so that the structures are interpenetrated with each other after the structure are hardened.

Regardless of applying crosslinking and hardening technologies to the humidity sensing polymer chain or using an interpenetrating network IPN structure to improve the water tolerance, the key point resides on finding a way of forming a crosslink structure on the humidity sensing polymer chain to meet the industrial requirement for a better water tolerance.

### SUMMARY OF THE INVENTION

Therefore, it is a primary objective of the present invention to provide an impedance type humidity sensing copolymer and its manufacture method and focus on finding a way of designing a crosslink structure formed on a humidity sensing polymer chain to improve the water tolerance of a polymer humidity sensing material. The invention mainly uses a humidity sensing copolymer having a humidity sensing leaving group and a reactive functional group to work together with a reactive functional group of a crosslinking agent to crosslink and combine the adjacent reactive functional group of the humidity sensing copolymer to produce a novel humidity sensing copolymer chain crosslink structure having a plurality of humidity sensing leaving groups, so as to achieve better effects on water tolerance and reliability.

Another objective of the present invention is to provide an impedance type humidity sensing copolymer and its manufacture method and further improves the water tolerance of a polymer humidity sensing material, in addition to designing a crosslink structure on a humidity sensing polymer chain. An independent crosslinking and hardening macromolecular system is mixed to form an interpenetrating network (IPN) structure to enhance the water tolerance and reliability.

A further objective of the present invention is to provide an impedance type humidity sensing copolymer and its manufacture method and design an adhesive structure between a humidity sensing polymer chain and a substrate material to enhance the adhesive force of a polymer humidity sensing material. A substrate of a humidity sensing element is coated with an enhanced adhesive film of a polymer having a reactive functional group and combined with the reactive functional group of the humidity sensing copolymer chain by crosslinking and hardening reactions to achieve the industrial requirement for a better adhesiveness.

### BRIEF DESCRIPTION OF THE FIGURES

FIG. 1 is a schematic view of producing a humidity sensing copolymer by a copolymerization in accordance with the present invention;

FIG. 2 is a schematic view of producing a humidity sensing copolymer chain by a crosslink reaction in accordance with the present invention;

FIG. 3 is a schematic view of producing a cubic bridge of a humidity sensing copolymer chain by a crosslink reaction in accordance with the present invention;

FIG. 4 is a schematic view of combining a humidity sensing copolymer chain by a crosslink reaction to form an interpenetrating network (IPN) structure in accordance with the present invention;

FIG. 5 shows a chemical formula of a tetraalkylammonium ionic conductive monomer of the present invention;

FIG. 6 shows a chemical formula of a sulfonate ionic conductive monomer of the present invention;

FIG. 7 is a schematic view of a humidity sensing copolymer being applied on a humidity sensing element in accordance with the present invention;

FIG. 8 is another schematic view of a humidity sensing copolymer being applied on a humidity sensing element in accordance with the present invention;

FIG. 9 shows chemical formulas of different humidity sensing copolymers of the present invention;

FIG. 10 shows test results of water tolerance tests and reliability tests conducted for controls in accordance with a preferred embodiment of the present invention; and

FIG. 11 shows other test results of water tolerance tests and reliability tests conducted as controls in accordance with a preferred embodiment of the present invention.

### DETAILED DESCRIPTION OF THE PREFERRED EMBODIMENT

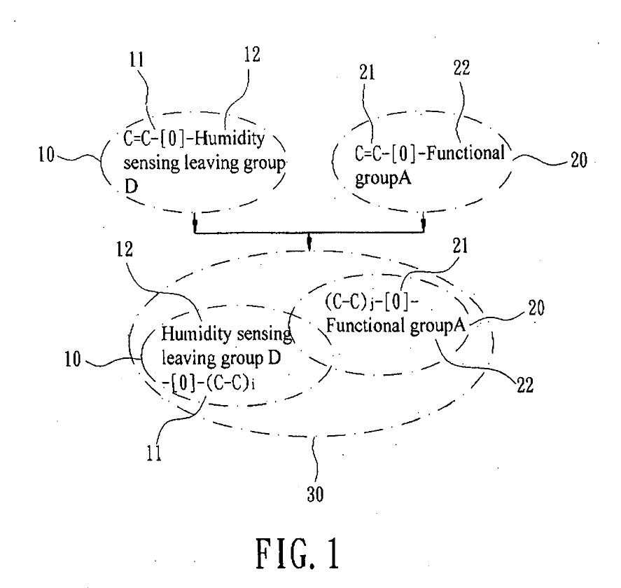

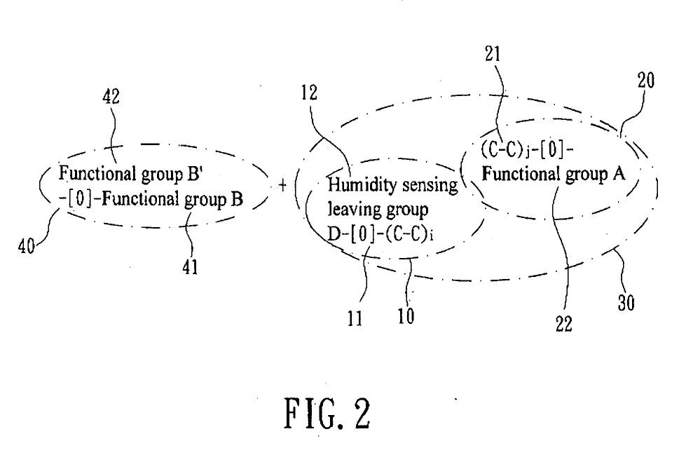

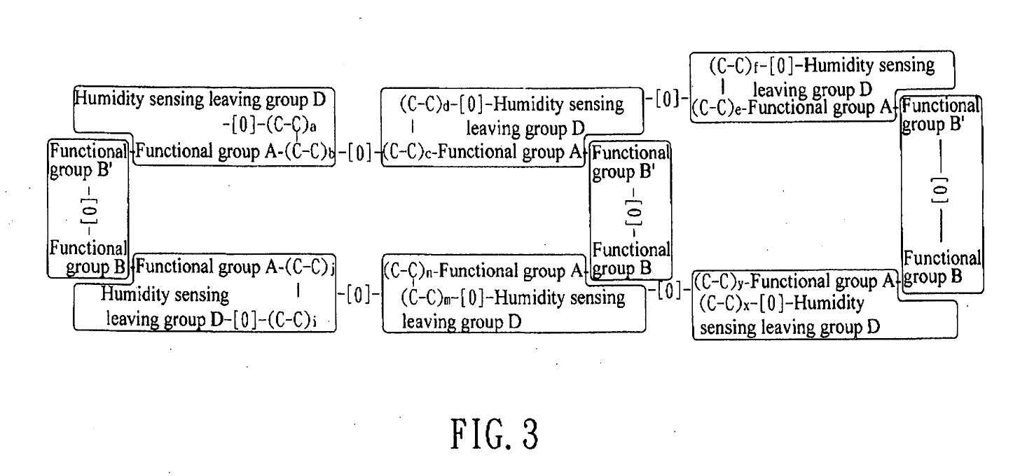

Referring to FIGS. 1 to 4, an impedance type humidity sensing copolymer of the present invention comprises the following elements:

a plurality of ionic conductive monomers 10, having a humidity sensing leaving group 12 and a reactive double bond 11;

a plurality of copolymerizing monomers 20, having a reactive functional group 22 and a reactive double bond 21; and

a crosslinking agent 40, having crosslinking functional groups 41, 42 capable of performing a crosslink reaction with the reactive functional group 22;

such that the reactive double bond 11 of the ionic conductive monomer 10 and the reactive double bond 21 of the copolymerizing monomer 20 are copolymerized to produce a humidity sensing copolymer 30, and the humidity sensing copolymer 30 includes a humidity sensing leaving group 12 and a reactive functional group 22, and the reactive functional group 42 of the crosslinking agent 40 is crosslinked with the adjacent reactive functional group 22 of the humidity sensing copolymer 30 to produce a chain crosslink structure having a plurality of humidity sensing leaving groups.

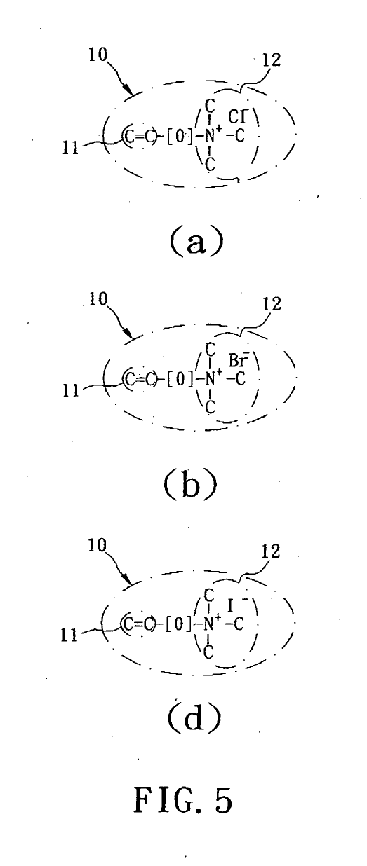

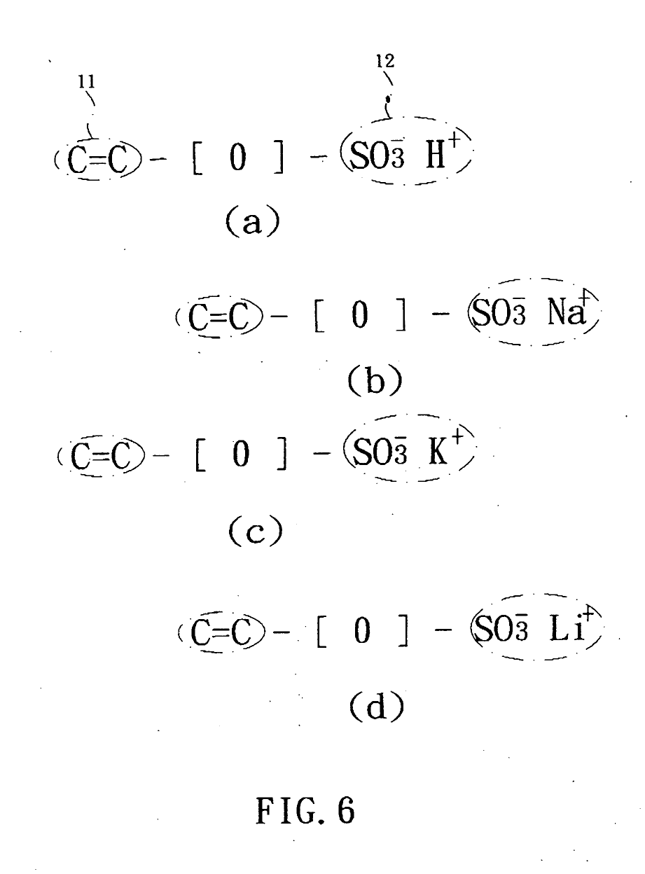

The reactive double bond 1121 in the ionic conductive monomer 10 or the copolymerizing monomer 20 can be a carbon-carbon (C═C) bond as shown in FIGS. 5 and 6, and the humidity sensing leaving group 12 in the humidity sensing copolymer 30 or the ionic conductive monomer 10 can be a tetraalkylammonium salt (—N+(R)₃X⁻) or a sulfonate (—SO₃⁻A⁺); and the portion X in the tetraalkylammonium salt (—N+(R)₃X⁻) of the humidity sensing leaving group can be Cl, Br, or I, and the portion A of the sulfonate (—SO₃⁻A⁺) of various different tetraalkylammonium salts (—N+(R)₃Cl⁻), (—N+(R)₃Br⁻) and (—N+(R)₃I⁻) or the humidity sensing leaving group can be H, Na, K, Li, for producing various different sulfonates (—SO₃—H⁺), (—SO₃—Na⁺), (—SO₃—K⁺) and (—SO3-Li⁺).

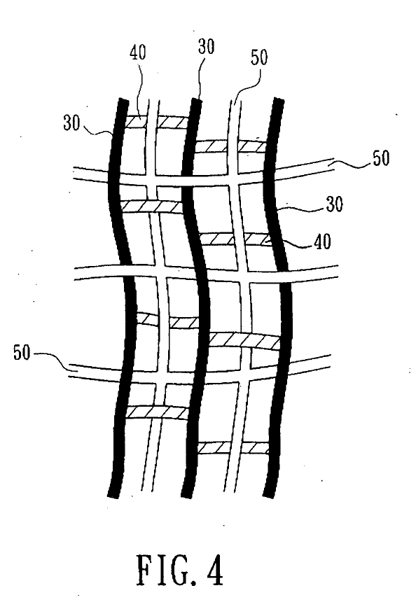

Referring to FIG. 4, the humidity sensing copolymer 30 chain is mixed with an independent crosslinking and hardening macromolecular system 50, when it is necessary to crosslink the reactive functional group 22 and the crosslinking agent 40, so that two polymer chains are interpenetrated with each other to form an interpenetrating network IPN structure.

The reactive functional group 22 of the copolymerizing monomer 20 can be composed of a carboxylic acid (—COOH), anhydride 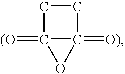
sulfur-hydrogen (—HS), hydroxyl (—OH), amine (—NH2), epoxy 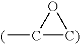
or isocyanate (—NCO) group. The crosslinking functional groups 41, 42 of the crosslinking agent 40 are composed of a carboxylic acid (—COOH), hydroxyl (—OH), amine (—NH2), epoxy 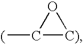
isocyanate (—NCO), cyanide (—N≡C), amide (—NHCO), oxazoline 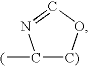
or carbodiimide (—R1-N═C═N—R2) group, and hardened and crosslinked with the reactive functional group 22 of the humidity sensing copolymer 30.

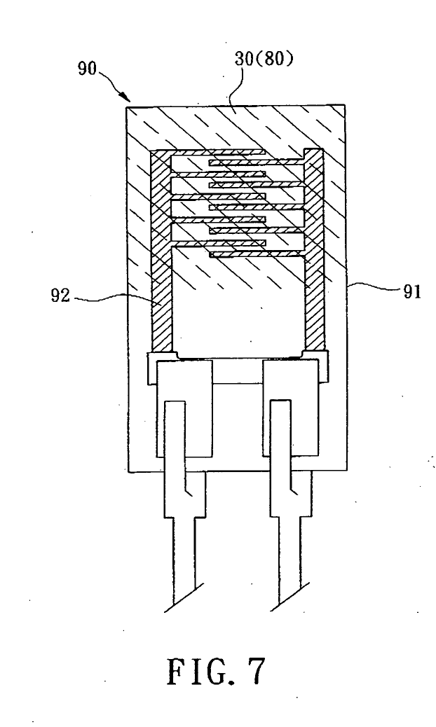

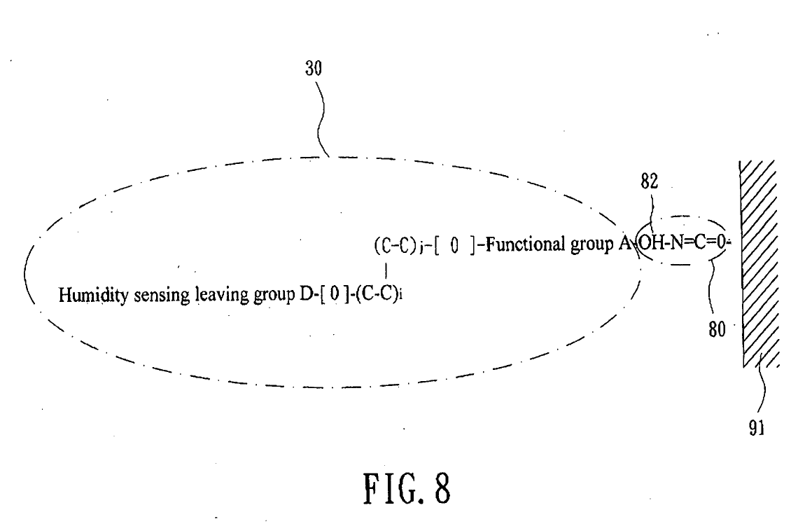

In FIGS. 7 and 8, an enhanced adhesive film 80 is coated between the reactive functional group 22 of the humidity sensing copolymer 30 chain and the substrate 91 of the humidity sensing element 90, and the enhanced adhesive film 80 is a polymer having a reactive functional group 82, and the reactive functional group 82 of the enhanced adhesive film 80 can be crosslinked and hardened with the reactive functional group 22 of the humidity sensing copolymer 30 chain.

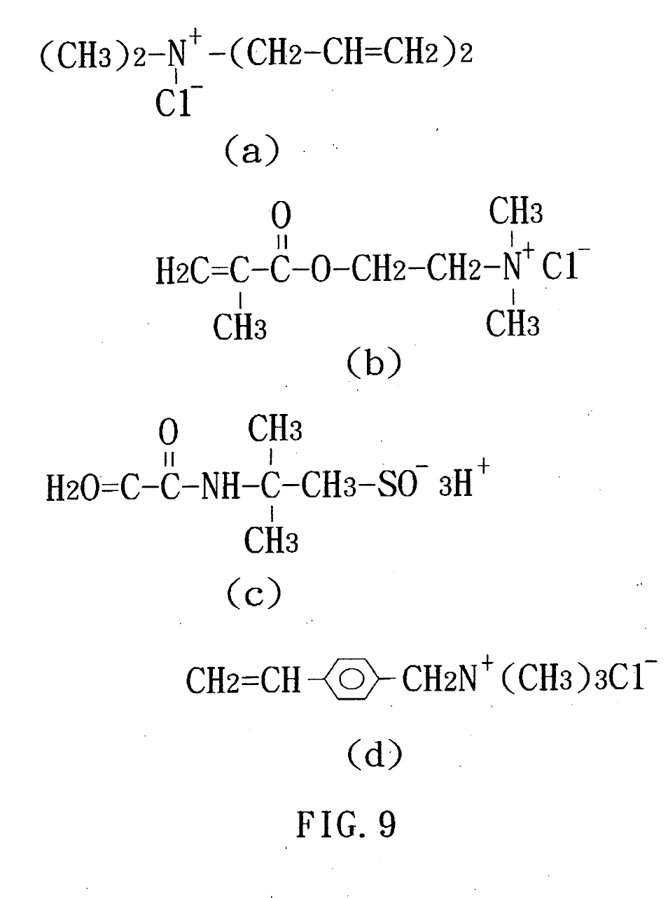

For an impedance type humidity sensing copolymer and its manufacture method in accordance with the present invention, various different humidity sensing copolymers as shown in FIG. 9 will be described below.

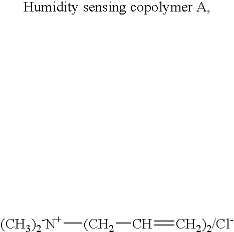

is composed of an ionic conductive monomer and 50 g of dimethyl diallyl ammonium chloride (DMDAC) (61 wt % of water solution), and 10 g of hydrophilic monomer acrylic acid) added to 0.3 g of terta-butyl hydroperoxide (80% water solution) and used as a reaction initiator mixed with a nitrogen gas at 70° C. for a copolymerization for 8 hours. After the reaction is finished, the content of solids is adjusted to 20wt % by deionized water.

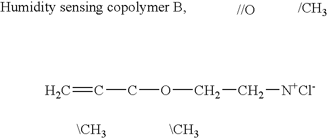

is composed of an ionic conductive monomer and 50 g of 2-trimethylammonium ethyl methacrylate chloride (TMAEMC) (75 wt % of water solution) and 12 g of hydrophilic monomer-methacrylamide added to and dissolved in 0.2 g of ammonium peroxodisulphate and mixed with nitrogen at 80° C. for a copolymerization for 2 hours. After the reaction, the content of solid is adjusted to 20 wt % by deionized water.

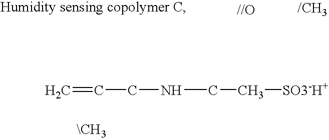

is composed of an ionic conductive monomer and 30 g of 2-acrylamido-2-methyl propane sulfonic acid (AMPS), and dissolved by 30 g of deionized water; and 10 g of 2-trimethylol propane diallyl ether is added into 0.2 g of ammonium peroxodisulphate to serve as a polymerizing initiator, and mixed in nitrogen at 80° C. for a copolymerization for 2 hours. After the polymerization is finished, the content of solid is adjusted to 20 wt % by deionized water.

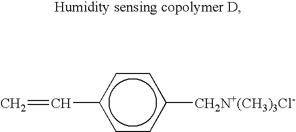

is composed of an ionic conductive monomer and 30 g of chloromethyl styrene quaternary ammonium salt, and dissolved in 30 g of deionized water, and mixed with 10 g of 2-hydroxye ethyl methacrylate, and added to 0.2 g of ammonium peroxodisulphate water-soluble peroxide as a polymerizing initiator, and the water solution is mixed with nitrogen at 80° C. for a copolymerization for 2 hours. After the reaction is finished, the content of solids is adjusted to 20 wt % by deionized water.

In a first embodiment, a crosslinking agent is added, and an IPN structure is used. Ten grams of temperature sensing polymer A is added and mixed to one gram of carbodiimide (50 wt % water solution), 0.5 gram of N,N Methylene-Bisacrylamide, 1 gram of acrylic acid and 0.01 g of ammonium peroxodisulphate, and the viscosity of the mixed humidity sensing polymer solution is adjusted to approximately 1000 cps, and after the substrate is dipped, the humidity sensing polymer mixture is coated evenly on an aluminum oxide substrate 91 having brush electrodes 92 by spin coating and baked at 180° C. for 2 hours to completely react and harden the polymer humidity sensing film, and the film thickness can be controlled within a range of 5-10 μm.

In a second preferred embodiment, a crosslinking agent is added and an IPN structure is used. Ten grams of humidity sensing polymer B is added to and mixed with 0.5 g of diisocyanate, 0.5 g of N,N methylene-bisacrylamide, 1 g of 2-hydroxyethyl methacrylate and 0.01 g of ammonium peroxodisulphate, and the viscosity of the humidity sensing polymer is adjusted to approximately 1000 cps by deionized water, and then the substrate is dipped in the mixed solution and the humidity sensing polymer mixture is coated evenly on an aluminum oxide substrate 91 having brush electrodes 92 by spin coating and baked at 180° C. for 2 hours to completely react and harden the polymer humidity sensing film.

In a first control, no crosslinking agent is added, but an IPN structure is used. Compared with the first embodiment, 10 g of humidity sensing polymer A is mixed evenly with 0.7 g of N,N methylene-bisacrylamide, 1.3 g of acrylic acid and 0.01 g of ammonium peroxodisulphate, the viscosity of the mixed humidity sensing polymer solution is approximately 1000 cps, and the substrate is dipped into the mixed humidity sensing polymer solution and the humidity sensing polymer mixture is coated evenly onto the aluminum oxide substrate 91 having brush electrodes 92 by spin coating, and then baked at 180° C. for 2 hours to completely react and harden the polymer humidity sensing film.

In a second control, no crosslinking agent is added, but an IPN structure is used. Compared with the second embodiment, 10 g of humidity sensing polymer B is mixed with 0.7 g of N,N methylene-bisacrylamide, 1.3 g of 2-hydroxyethyl methacrylate and 0.01 g of ammonium peroxodisulphate, and the viscosity of the mixed humidity sensing polymer solution is adjusted to approximately 1000 cps by deionized water, and then the substrate is dipped into the humidity sensing polymer mixture, and the humidity sensing polymer mixture is coated evenly on the aluminum oxide substrate 91 having a pair of brush electrodes 92 by deionized water, and finally baked at 180° C for 2 hours to completely react and harden the polymer humidity sensing film.

In a third embodiment, a crosslinking agent is added and an IPN structure is used. Ten grams of humidity sensing polymer C is added to 0.5 g of epoxy and 0.5 g of trifunction acrylic monomer), 1 g of methacrylamide, and 0.01 g of ammonium peroxodisulphate, and the viscosity of the humidity sensing polymer mixture is adjusted to 1000 cps by deionized water, and the substrate is dipped, and the humidity sensing polymer mixture is coated evenly on a substrate 91 having a pair of brush electrodes 92 by spin coating, and finally baked at 180° C. for 2 hours to completely react and harden the polymer humidity sensing film.

In a fourth embodiment, a crosslinking agent is added, and an IPN structure is used, and a coating adhesive film is adopted. Similar to the third embodiment, a ceramic substrate 91 having a pair of brush electrodes 92 is dipped into 10 wt % of diisocyanate solution and then baked at 160° C. for 30 minutes. The rest of the manufacturing process is the same as that for the third embodiment.

In a third control, no crosslinking agent is added, but an IPN structure is used. Compared with the third embodiment, 10 g of humidity sensing polymer C is mixed with 0.7 g of trifunction acrylic monomer having 3 reactive double bonds, 1.3 g of methacrylamide and 0.01 g of ammonium peroxodisulphate, and the viscosity of the solution is adjusted to 1000 cps by deionized water, and the substrate is dipped into the mixed humidity sensing polymer solution, and the humidity sensing polymer mixture is coated onto a substrate 91 having a pair of brush electrodes 92 by spin coating, and finally baked at 180° C. for 2 hours to completely react and harden the polymer humidity sensing film.

In a fifth embodiment, a crosslinking agent is added and an IPN structure is used. Ten grams of humidity sensing polymer D is added and mixed evenly with 0.5 g of diisocyanate and 0.5 g of trifunction acrylic monomer having three reactive double bonds, 1 g of acrylic acid monomer and 0.01 g of ammonium peroxodisulphate, the viscosity of the mixed humidity sensing polymer solution is adjusted to approximately 1000 cps, and the substrate is dipped into the mixed humidity sensing polymer solution, and the humidity sensing polymer mixture is coated evenly on a substrate 91 having a pair of brush electrodes 92, and finally baked at 180° C. for 2 hours to completely react and harden the polymer humidity sensing film.

In a sixth embodiment, a crosslinking agent is added, and an IPN structure is used, and a coating adhesive film is adopted.

Similar to the fifth embodiment, a substrate 91 having a pair of brush electrodes 92 is dipped into 10 wt % of epoxy solution and then baked at 160° C. for 30 minutes, and the rest of the manufacturing process is the same as that of the fifth embodiment.

In a fourth control, no crosslinking agent is added, but an IPN structure is used and a coating adhesive film is adopted. Compared with the sixth embodiment, no diisocyanate is added, and the rest of the manufacturing process is the same as that of the sixth embodiment.

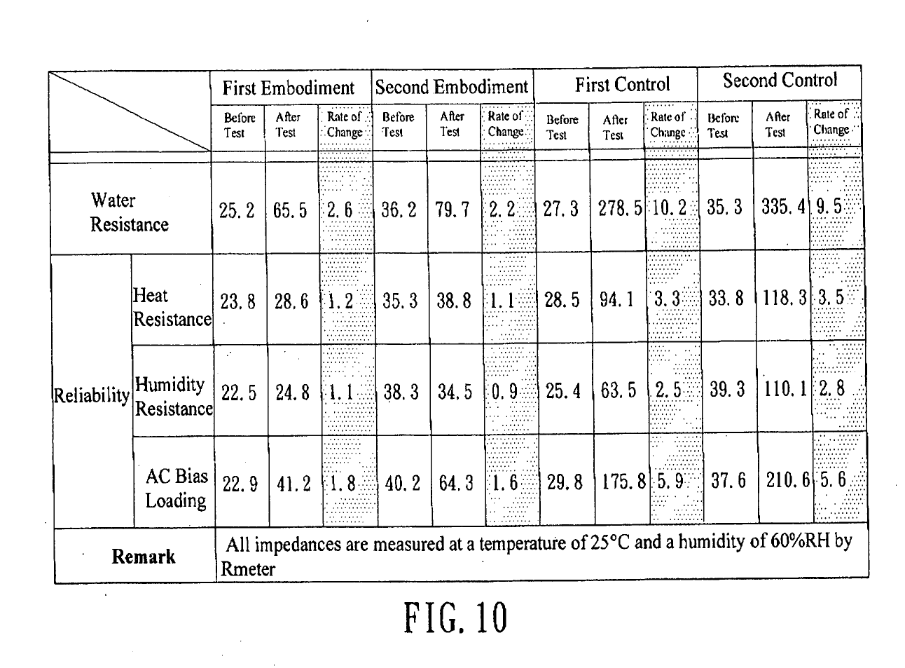

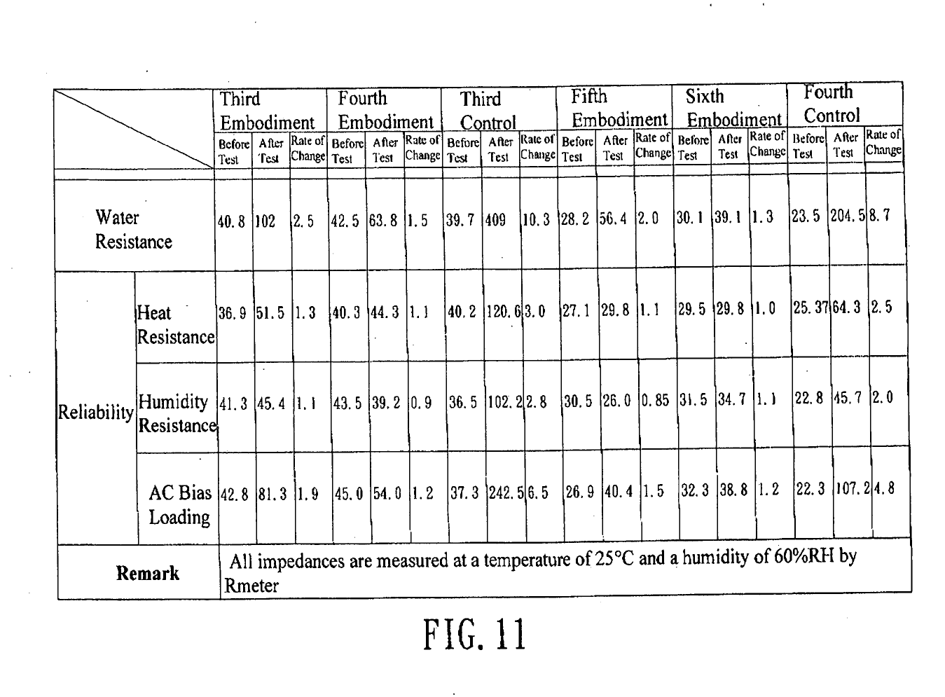

All samples of the foregoing embodiments and controls go through a water tolerance test and a reliability test for evaluations, and the test results are shown in FIGS. 10 and 11, and the testing methods and conditions are listed below:

(a) Water Tolerance Test:

The humidity sensing element is dipped into deionized water at 25° C. for 30 minutes, and placed in the air with constant temperature and constant humidity for 24 hours. The impedance measured at a temperature of 25° C. and a humidity of 60% RH is compared with the impedance measured at a temperature of 25° C. and a humidity of 60% RH before dipping, and the measurements taken after dipping are recorded, so as to obtain the rate of change of impedance before and after dipping.

(b) Reliability Test:

1. Heat Resistance (High Temperature Storage)

The humidity sensing element is placed in the air at a temperature of 85° C. and at a humidity of 30% RH for 1000 hours, and measurements before and after the test taken at a temperature of 25° C. and a humidity of 60% RH are recorded to compare the rate of change of impedance.

2. Humidity Resistance (High Temperature and High Humidity Storage)

The humidity sensing element is placed in the air at a temperature of 60° C. and a humidity of 90% RH for 1000, and measurements before and after the test taken at a temperature of 25° C. and a humidity of 60% RH are compared to determine the rate of change of impedance.

3. AC Bias Loading

The humidity, sensing element is placed in the air at a temperature of 60° C. and a humidity of 90% RH, and a square wave of AC 5V 1 KHz is applied continuously (without any DC) for 150 hours, and measurements of the impedance taken at a temperature of 25° C. and a humidity of 60% RH before the bias loading are compared to obtain the rate of change of impedance.

In summation of the description above, the impedance type humidity sensing copolymer and the method of producing the same in accordance with the present invention, the humidity sensing polymer chain includes a reactive functional group and adds a crosslinking agent for performing a crosslink reaction to produce a humidity sensing copolymer chain crosslink structure having a plurality of humidity sensing leaving groups. In the foregoing humidity sensing polymer material solution, an independent crosslinking and hardening macromolecular system is added, so that two polymer hardening systems can be crosslinked separately by heating (radiating with UV) to interpenetrate two polymer chains with each other.

The samples of the foregoing embodiments and controls go through the evaluation by a water tolerance test and a reliability test, and the test results show that the humidity sensing polymer material of the invention absorbs moisture easily, but a crosslinking agent is used for producing a crosslink structure of a humidity sensing copolymer chain, under the repeatedly dry and wet environment and the effect of dews over a long period of time, so as to prevent excessive adsorption of water molecules, dissolving and expanding the humidity sensing polymer material, as well as enhancing the reliability of using the humidity sensing element over a long period of time.

Further, another independent crosslinking and hardening macromolecular system is mixed into the humidity sensing polymer material solution, such that two polymer chains are interpenetrated with each other to produce an interpenetrating network IPN structure, and enhance the reliability and stability of using the humidity sensing element over a long period of time.

Further, a polymer enhanced adhesive film having a reactive functional group is coated on a substrate of the humidity sensing element and combined with a reactive functional group of a humidity sensing copolymer chain by crosslinking and hardening reactions to improve the adhesive force between a polymer humidity sensing material and a substrate and prevent an exfoliation occurred at an interface between the humidity sensing polymer material and the substrate, so as to achieve the effects of providing better adhesiveness, enhancing the reliability of using the humidity sensing element over a long period of time, and eliminating the possibility of a change, distort, or loss of the original properties of the humidity sensing element.

What is claimed is:

1. An impedance type humidity sensing copolymer, comprising:
a plurality of ionic conductive monomers, having a humidity sensing leaving group and a reactive double bond;
a plurality of copolymerizing monomers, having a reactive functional group and a reactive double bond; and
a crosslinking agent, having a crosslinking functional group for crosslinking with said reactive functional group;
such that said reactive double bond in said ionic conductive monomer and said reactive double bond of said copolymerizing monomer are copolymerized to produce a humidity sensing copolymer, and said humidity sensing copolymer includes a humidity sensing leaving group and a reactive functional group, and said reactive functional group of said crosslinking agent is crosslinked with said adjacent reactive functional group of said humidity sensing copolymer are crosslinked to produce a humidity sensing copolymer chain crosslink structure having a plurality of humidity sensing leaving groups.

2. The impedance type humidity sensing copolymer of claim 1, wherein said reactive double bond in said ionic conductive monomer or said copolymerizing monomer is a carbon-carbon (C═C) reactive double bond.

3. The impedance type humidity sensing copolymer of claim 1, wherein said humidity sensing leaving group in said humidity sensing copolymer or said ionic conductive monomer is a tetraalkylammonium salt (—N⁺(R)₃X⁻) or a sulfonate (—SO₃⁻A⁺).

4. The impedance type humidity sensing copolymer of claim 3, wherein said humidity sensing leaving group in said humidity sensing copolymer or said ionic conductive monomer is a tetraalkylammonium salt (—N⁺(R)3X⁻), and the portion X of tetraalkylammonium salt (—N⁺(R)3X⁻) is Cl, Br or I for producing various different tetraalkylammonium salts (—N⁺(R)₃Cl⁻), (—N⁺(R)₃Br⁻) and (—N⁺(R)₃I⁻), or the portion A of sulfonate (—SO₃⁻A⁺) of said humidity sensing leaving group is H, Na, K or Li for producing various different sulfonates (—SO3⁻H⁺), (—SO³—Na⁺), (—SO3⁻K⁺) and (—SO3⁻Li⁺).

5. The impedance type humidity sensing copolymer of claim 1, wherein said humidity sensing copolymer chain is mixed independently with a crosslinking and hardening macromolecular system if it is necessary to crosslink and combine said reactive functional group and said crosslinking agent, such that two polymer chains are interpenetrated with each other to produce an interpenetrating network IPN structure.

6. The impedance type humidity sensing copolymer of claim 1, wherein said reactive functional group of said copolymerizing monomer is composed of a carboxylic acid (—COOH), anhydride 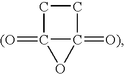
sulfur-hydrogen (—HS), hydroxyl (—OH), amine (—NH2), epoxy 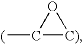
or isocyanate (—NCO) group.

7. The impedance type humidity sensing copolymer of claim 1, wherein said crosslinking functional group of said crosslinking agent is composed of a carboxylic acid (—COOH), hydroxyl (—OH), amine (—NH₂), epoxy 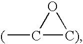
isocyanate (—NCO), cyanide (—N≡C), amide (—NHCO), oxazoline 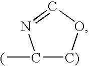
or carbodiimide (—R1-N═C═N—R₂) group, and hardened and crosslinked with said reactive functional group of said humidity sensing copolymer.

8. The impedance type humidity sensing copolymer of claim 1, further comprising an enhanced adhesive film disposed between said reactive functional group of said humidity sensing copolymer chain and a substrate of said humidity sensing element, and said enhanced adhesive film having a polymer with a reactive functional group, and said reactive functional group of said enhanced adhesive film can be crosslinked and hardened with said reactive functional group of said humidity sensing copolymer chain.

9. A method for producing an impedance type humidity sensing copolymer, comprising:
a first step, for polymerizing reactive double bonds of a plurality of ionic conductive monomers having humidity sensing leaving groups and reactive double bonds of a plurality of copolymerizing monomers of said reactive functional group to produce a humidity sensing copolymer, and said humidity sensing copolymer having a humidity sensing leaving group and a reactive functional group;
a second step, for adding a crosslinking agent to crosslink said crosslinking functional group of said reactive functional group with said adjacent reactive functional group of said humidity sensing copolymer to produce a humidity sensing copolymer chain crosslink structure having a plurality of humidity sensing leaving groups.

10. The method for producing an impedance type humidity sensing copolymer of claim 9, wherein said reactive double bond in said ionic conductive monomer or said copolymerizing monomer is a carbon-carbon (C═C) reactive double bond.

11. The method for producing an impedance type humidity sensing copolymer of claim 9, wherein said humidity sensing leaving group in said humidity sensing copolymer or said ionic conductive monomer is a tetraalkylammonium salt (—N⁺(R)₃X⁻) or a sulfonate (—SO₃⁻A⁺).

12. The method for producing an impedance type humidity sensing copolymer of claim 11, wherein
said humidity sensing leaving group in said humidity sensing copolymer or said ionic conductive monomer is a tetraalkylammonium salt (—N⁺(R)3X⁻), and the portion X of tetraalkylammonium salt (—N⁺(R)3X⁻) is Cl, Br or I for producing various different tetraalkylammonium salts (—N+(R)₃Cl—), (—N⁺(R)₃Br⁻) and (—N⁺(R)₃I⁻), or the portion A of sulfonate (—SO₃⁻A⁺) of said humidity sensing leaving group is H, Na, K or Li for producing various different sulfonates (—SO3⁻H⁺), (—SO³—Na⁺), (—SO3⁻K⁺) and (—SO3⁻Li⁺).

13. The method for producing an impedance type humidity sensing copolymer of claim 9, wherein said humidity sensing copolymer chain is mixed independently with a crosslinking and hardening macromolecular system if it is necessary to crosslink and combine said reactive functional group and said crosslinking agent, such that two polymer chains are interpenetrated with each other to produce an interpenetrating network IPN structure.

14. The method for producing an impedance type humidity sensing copolymer of claim 9, wherein said reactive functional group of said copolymerizing monomer is composed of a carboxylic acid (—COOH), anhydride 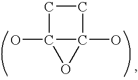
sulfur-hydrogen (—HS), hydroxyl (—OH), amine (—NH2), epoxy 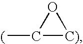
or isocyanate (—NCO) group.

15. The method for producing an impedance type humidity sensing copolymer of claim 9, wherein said crosslinking functional group of said crosslinking agent is composed of a carboxylic acid (—COOH), hydroxyl (—OH), amine (—NH₂), epoxy 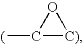
isocyanate (—NCO), cyanide (—N≡C), amide (—NHCO), oxazoline 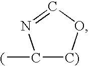
or carbodiimide (—R1-N═C═N—R2) group and hardened and crosslinked with said reactive functional group of said humidity sensing copolymer.

16. The method for producing an impedance type humidity sensing copolymer of claim 9, further comprising an enhanced adhesive film disposed between said reactive functional group of said humidity sensing copolymer chain and a substrate of said humidity sensing element for providing a better adhesion of said substrate, and said enhanced adhesive film having a polymer with a reactive functional group, and said reactive functional group of said enhanced adhesive film can be crosslinked and hardened with said reactive functional group of said humidity sensing copolymer chain.

17. The method for producing an impedance type humidity sensing copolymer of claim 16, wherein said enhanced adhesive film with good adhesiveness is coated onto said substrate of said humidity sensing element, and said humidity sensing copolymer material is coated onto of said enhanced adhesive film after a preliminary drying, and then heated (radiated by UV) to crosslink and harden said reactive functional group on said humidity sensing copolymer chain and said reactive functional group of said enhanced adhesive film on said substrate.
